(19) United States
(12) Patent Application Publication
(10) Pub. No.: US 2018/0143448 A1
(43) Pub. Date: May 24, 2018

(54) Virtual Reality Post Card

(71) Applicant: Luc Lam, Lake Villa, IL (US)

(72) Inventor: Luc Lam, Lake Villa, IL (US)

(21) Appl. No.: 15/359,647

(22) Filed: Nov. 23, 2016

(51) Int. Cl. G02B 27/22; G02B 27/02

(52) U.S. Cl. CPC G02B 27/2257; G02B 27/028

(57) ABSTRACT

A virtual reality viewer reconfigured from a standard post card such that the post card is transformed into a three dimensional body and attached to a cell phone to view a three dimensional scene . The folds on the outside of the post card enable the post card to form the virtual reality viewer. The post card also includes a set of lenses and a locking mechanism to hold the viewer onto the cell phone.

### CROSS-REFERENCE TO RELATED APPLICATIONS

This application claims the benefit of U.S. provisional patent application entitled “Virtual Reality Post Card” filed, Nov. 23,2015 and assigned Ser. No. 62/258,679, and U.S. provisional patent application entitled “Virtual Reality Post Card” filed, Apr. 8, 2016, 2011 and assigned Ser. No. 62/319,897 which are incorporated by reference in their entireties.

### BACKGROUND OF THE INVENTION

The present invention relates generally to post cards and more particularly to post cards viewed with an integrated virtual reality viewer. More particularly, the present invention relates to a post card that may be reconfigured from a standard post card and formed into a virtual reality viewer that is attachable to a smart phone.

Even in today's high technology world of ubiquitous internet connectivity, smart phones, and multimedia messaging services, sending post cards remains a time-honored tradition. However, even with the growth of low-cost digital devices, post card technology has remained largely unchanged. Post cards generally only provide a two-dimensional image to the recipient. Accordingly, there is an opportunity to enhance post cards to provide improved multimedia experiences.

One approach to providing improved multimedia experiences is the use of virtual reality through virtual reality viewers. A virtual reality viewer may give the recipient the sense that they are present at the location where the image was taken. However, providing a post card along with a virtual reality viewer has not been a cost effective option. Previous virtual reality viewers disadvantageously have not been able to be shipped through standard mail without additional packaging to protect the viewer. Additionally, previous virtual reality viewers were expensive, often exceeding the cost of a post card.

Accordingly, there is a need for a post card that is reconfigurable into a virtual reality viewer, but is still able to be shipped through standard mail without additional packaging due to its size, weight, shape, flexibility, and durability and is then attachable to a smart phone, such that the post card is viewed as a virtual reality scene.

### SUMMARY OF THE INVENTION

The present invention provides for a post card that may be reconfigured from a standard post card configuration into a virtual reality viewer, attached to a smart phone, and be used to view a virtual reality scene. By providing a post card that may be reconfigured into a virtual reality viewer, the present invention provides a virtual reality viewer that may be shipped through standard mail without additional packaging due to its size, weight, shape, flexibility, and durability.

In the virtual reality viewer configuration, the post card may be attached to a smart phone and allow a user to view a three-dimensional image via a two-dimensional screen while utilizing applications and software on the smart phone. The virtual reality post card generally comprises a lens holder and two lenses. Each lens focuses on a different image, one per each eye. When used by the user, the brain combines the two different images into one three-dimensional scene. This allows the user to view stereoscopic images having the illusion of depth perception.

By providing a virtual reality post card, the disclosed invention allows the recipient of the post card to quickly and efficiently reconfigure the post card into a virtual reality viewer and experience stereoscopic images while viewing the pictures through a smart phone.

One advantage of the disclosed invention is that it is a single body design, adding structural rigidity to the structure. Thus, the post card may be mailed as any normal postcard. Additionally, the single body design reduce part counts, thus lowering manufacturing cost, while also simplifying the reconfiguration process to form a post card to a virtual reality viewer.

Another advantage of the disclosed invention is that it is pliable, allowing the post card to flex through mail sorting machines without being damaged. This design also enables the virtual reality viewer to be fastened to the top and bottom of a phone by a number of different means, including adhesives or elastic fasteners. The fastening means may vary without changing the conception of the invention. The smart phone provides structural support for the viewer when the recipient is viewing the stereoscopic images. This feature also allows the lenses to remain centered and parallel to the screen and at an appropriate focal distance from the screen, providing optimal viewing conditions.

Still another advantage of the invention of the invention is that the post card is formed from an interior and exterior sheet having lenses, which may be stereoscopic, maintained between the two sheets. The interior sheet encompasses a number of folds/perforations which allow the sheet to move in such a way to form a virtual reality viewer, including attaching to a cell phone. The particular formation of the viewer keeps out any undesirable light from the top, bottom and sides of the viewer.

Yet still another advantage of the invention is a locking mechanism, which may be used in conjunction with an elastic string holding the viewer in place on a cell phone. Either the top or bottom edge of the viewer may include an aperture and a slot. One end of the elastic is thread through a hole in the card and held in place while the opposite end of the elastic slides fits into the aperture and then is locked in place in the slot. Alternatively, the locking mechanism may include a channel and opening in the fold above the lenses. The elastic is positively locked inside the opening preventing slippage.

Additional objects, advantages and novel features of the examples will be set forth in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawings and figures depict one or more implementation in accordance with the present concepts, by way of example only, not by way of limitations. In the figures, like reference numerals refer to the same or similar elements.

FIGS. 1A and 1B are exterior views of a virtual reality post card;

FIG. 2 is a diagram of or exterior surface of a piece of card stock before assembly;

FIGS. 3A-C are diagrams illustrating the assembly steps for a virtual reality post card;

FIGS. 4A-D are perspective views of the virtual reality post card formed into a stereoscopic viewing platform and attached to a phone respectively; and

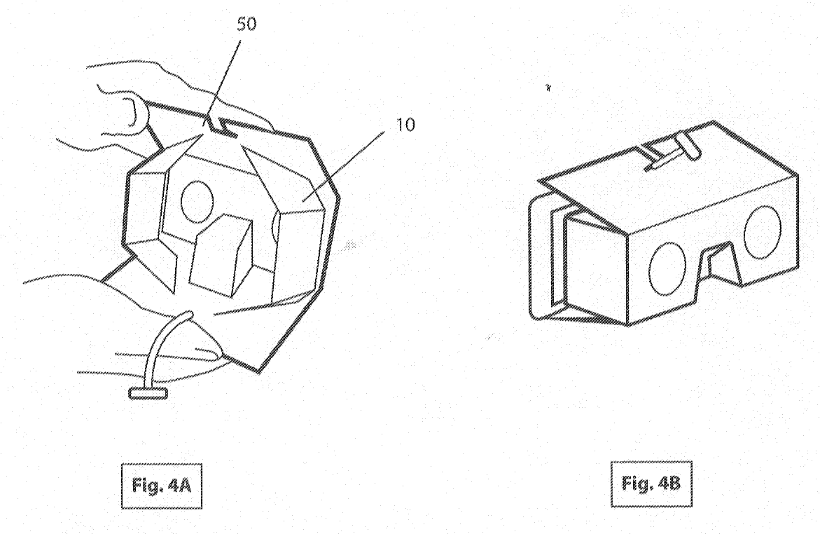

FIGS. 5A and 5B show an alternative locking mechanism.

### DETAILED DESCRIPTION OF THE INVENTION

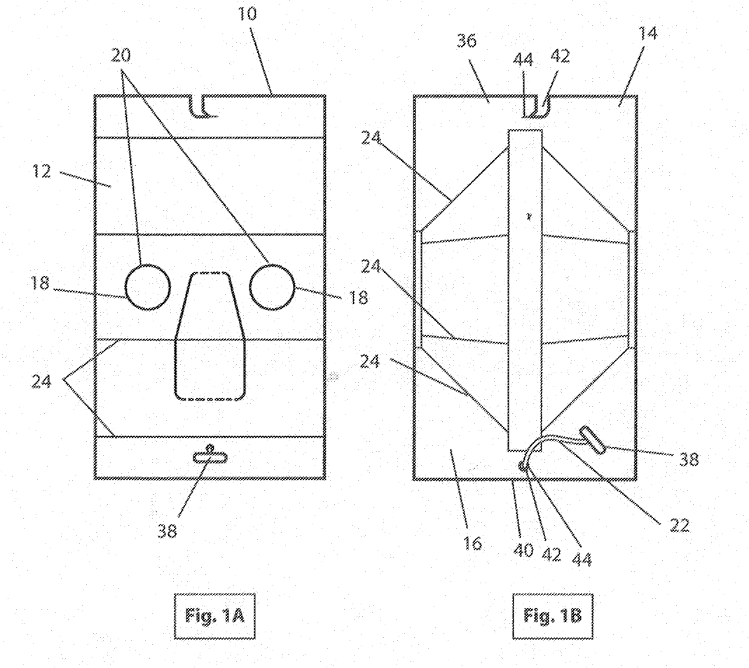

The virtual reality post card system 10 is described below and shown in the accompanying figures. The front 12 and back 14 of a flat post card 16 is shown in FIGS. 1A and 1B respectively. As shown in FIG. 1A, the front 12 of the card contains a printed picture or image similar to any typical post card. The front 12 of the card also includes two cut outs 18 such that the lenses 20 may be visible. From the back side of the card, shown in FIG. 1B, an elastic 22 to hold the post card in place on a cell phone, not shown, is visible. Also shown are the folds 24, which are utilized to expand the back of the post card 16 and transform the post card into a virtual reality viewer 10. The postcard pops-up or activates to deploy the structural frame of the virtual reality viewer. Once a person is finished using the viewer, the back 14 of the post card may be folded back down and stored flat for easy storage.

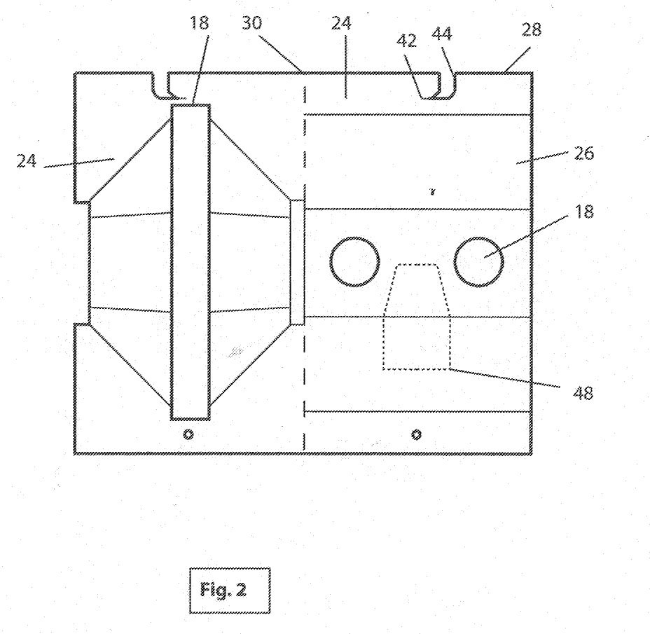

FIG. 2 Illustrates an exterior surface 26 of a piece of card stock 28. The card stock includes fold lines 24, cut outs 18, center line 30.

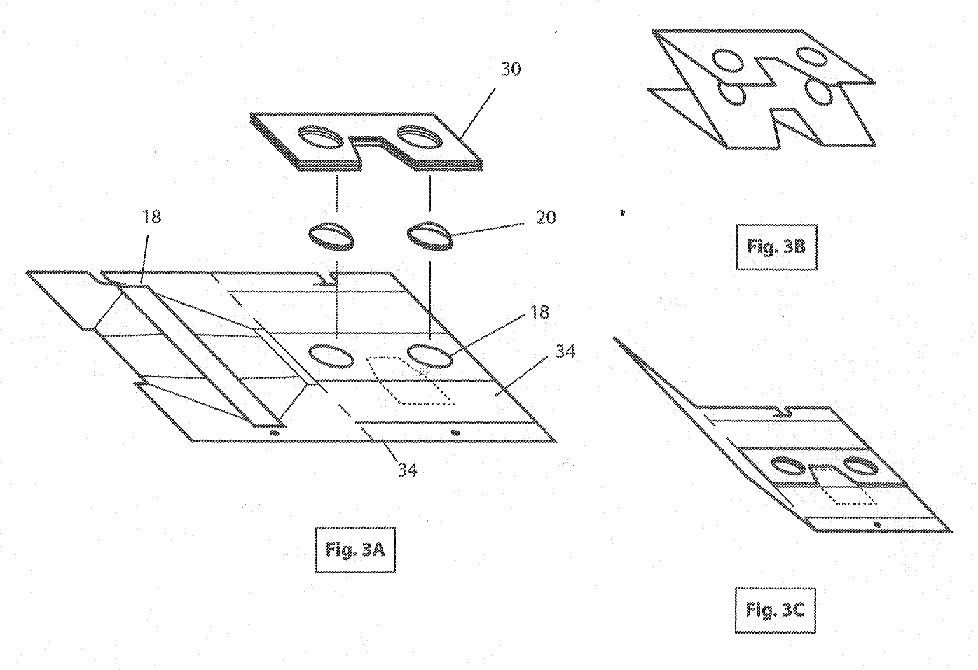

As shown in FIGS. 3A-3B, are the steps illustrating the assembly of the virtual reality viewer 10. A lens retainer 32 is tri-folded. A set of lenses 20 is then placed over the cutouts 18 on the interior surface 34 of the card 28. The card stock is folded in half along the center line 30 and sealed together. Not shown is the elastic cord, which is used to hold the viewer onto a cell phone.

Alternatively, two sheets may replace the heavier card stock are glued together and substituted for the heavier card stock. The interior and exterior sheets may be comprised of many different materials as long as the materials are strong enough to function as the reality viewer. For instance, the layers may be plastic which are sonically glued or sealed together. Also the lens retainer may be substituted with a single layer containing an indexing feature such that the lenses sit therein. As long as the materials are functionally equivalent and the lenses remain centered, and at an appropriate focal distance from the screen the materials may be interchangeable.

FIG. 3A shows the virtual reality viewer completely unfolded. It is the use of the combination of foldable lines 24 on the back side of the card that allow the card to be opened in such a fashion that when the viewer is attached to a cell phone, the viewer allows for the lenses to remain centered and parallel to the screen and at an appropriate focal distance from the screen, providing optimal viewing conditions. The viewer itself, blocks out all external light, which makes it easier to use and see the images in the phone. Due to the particular formation of the viewer, only one size viewer is needed for any size phone. The viewer is used in conjunction with software and applications on the cell phone that it is attached to as shown in FIG. 3B .

The attaching mechanism shown in the figures is an elastic cord 22 however other attaching mechanisms may be utilized including adhesives or an extra sheet added on in the back and which acts a card cover. The fastening means may vary without changing the conception of the invention. As shown in FIG. 1B, one end of the elastic cord is threaded through one of the short ends 36 of the card and held in place with and aglet or cord stopper 38 on the opposite side of the card. The opposite end of the cord is threaded through the opposite short end of the card 40. However, as shown in the figures, the card includes an aperture 42 and a slot 44. The elastic is slid into the aperture and then into the slot. This locks the elastic in place.

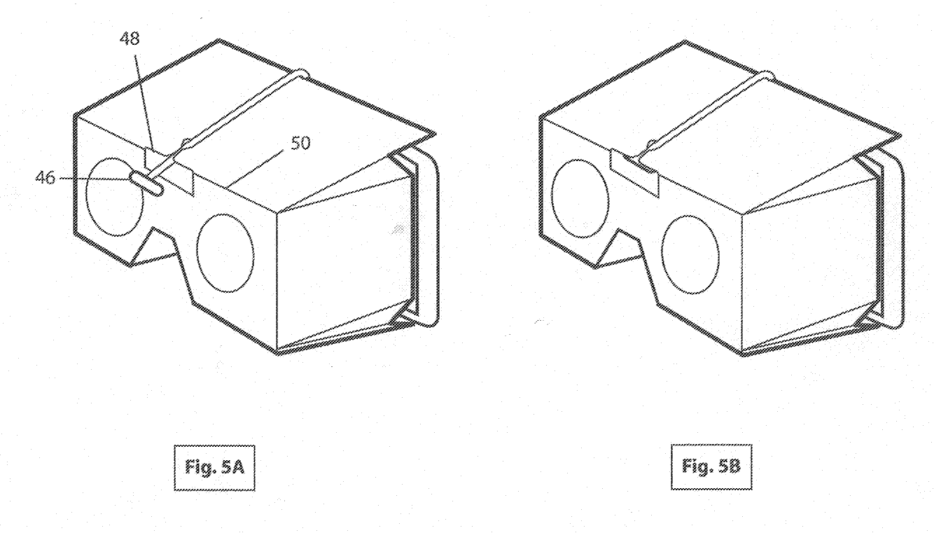

Alternatively, as shown in FIG. 5, the elastic is pulled into a channel 46 and opening 48 in the fold 50 above the lenses. When released, the elastic tip is positively locked inside the opening preventing slippage. Other similar locking mechanisms may also be utilized. Also shown is an optional cutout 48 which may be curved or positioned out of the way or removed such that a user of the system may fit their nose into the cutout to for ease of use. The piece may also be removed to allow access to the touch screen of the phone.

Although the present invention has been shown and described with respect to several preferred embodiments thereof, various changes, omissions and additions to the form and detail thereof, may be made therein, without departing from the spirit and scope of the invention

What is claimed:

1. A virtual reality viewer, said viewer comprising:
a) an exterior sheet having a two dimensional picture thereon;
b) an interior sheet, said interior sheet comprising fold lines;
c) a set of lenses wherein said lenses is positioned between the interior and exterior sheets ; and
d) attaching mechanism to hold said viewer on a cell phone, wherein said folds of said interior sheet allow said interior sheet to form a three dimensional viewer such that a person attaches said viewer to a cell phone with the attaching mechanism and views said two dimensional picture thereon through software on the phone and the lenses in the viewer such that the two dimensional picture appears three dimensional.

2. The viewer of claim 1, wherein the viewer includes a lens retainer.

3. The viewer of claim 1, wherein the lenses are stereoscopic.

4. The viewer of claim 1, said attaching means includes and elastic cord.

5. The viewer of claim 1, wherein the viewer prevents outside light from interfering with viewing the picture on the exterior sheet.

6. The viewer of claim 4, the viewer includes a locking mechanism for the elastic cord.

7. The viewer of claim 6, wherein the locking mechanism includes and aperture and slot in the sheets such that the elastic slides therein to lock therein.

8. The viewer of claim 6, wherein the locking mechanism includes an opening in a fold above the lenses where said cord feeds through.

9. A virtual reality viewer, said viewer comprising:
a) a sheet having a two dimensional picture on one side thereof;
b) a box portion attached to the sheet on the opposite side of the picture, said box portions having folds therein;
c) a set of lenses wherein said lenses are positioned between the box portion and the sheet; and
d) attaching mechanism, wherein said folds of said box portion form a three dimensional viewer such that a person attaches said viewer to a cell phone with the attaching mechanism and views a two dimensional picture thereon through software on the phone and the lenses in the viewer such that the two dimensional picture appears three dimensional.
